(19) United States
(12) Patent Application Publication
(10) Pub. No.: US 2015/0194013 A1
(43) Pub. Date: Jul. 9, 2015

(54) GAMING METHOD AND SYSTEM TO SELECTIVELY ALLOW WAGERING AND NON-WAGERING PLAY BASED ON GEOGRAPHICAL LOCATION

(71) Applicant: Loot City LLC, New York, NY (US)

(72) Inventor: Rollin Herold, New York, NY (US)

(21) Appl. No.: 14/576,646

(22) Filed: Dec. 19, 2014

Related U.S. Application Data
(60) Provisional application No. 61/920,853, filed on Dec. 26, 2013.

(51) Int. Cl. G07F 17/32

(52) U.S. Cl. CPC G07F 17/3225; G07F 17/3244

(57) ABSTRACT

A mobile device for gaming is loaded with software that communicates with proximity beacons in a gaming environment. When within a predetermined, legal distance to the proximity beacons, the mobile device provides gaming play for monetary wagers and additional venue specific advertising and information. When a user is beyond the predetermined communication distance of a proximity beacon, the device's cellular communications takes over and provides play-for-fun (non-monetary) gaming as well as other information from a remote server.

### CROSS-REFERENCE TO RELATED APPLICATIONS

This application claims the benefit of priority under 35 U.S.C. 119(e) to U.S. Provisional Patent Application No. 61/920,853, filed Dec. 26, 2013, the entire contents of which are hereby incorporated by reference in their entirety.

### FIELD OF THE INVENTION

The present invention relates to portable, wireless video gaming methods and systems. More particularly, the present invention relates to portable, wireless video gaming methods and systems that selectively provide wagering and non-wagering functionality based on geographic location.

### BACKGROUND OF THE INVENTION

On-line gambling and portable gaming systems are known in the art. In recent years, at least in the United States, a number of laws have been enacted to curtail the prevalence of gambling for money through on-line activities. For the most part, in the United States, in order to be able to play games of chance for money, a participant must be present within the geographic boundaries where the gaming is permissible by state law. The geographic limits on legal casino gambling greatly limits the practicability of conducting these activities on wireless devices. As will be appreciated, wireless devices by their nature are designed for portability and mobility, thus not being tied to a specific geographic location for operation and service. The inability to identify and police the physical location of mobile gamers makes the provision of gambling activities in the mobile network environment impractical. In other words, there is a real concern that mobile users outside the legal wagering boundaries of a casino (or other legal gambling establishment) could access the casino's gaming server and illegally participate in gaming activities if wireless access was permitted.

In an effort to police the geographic location of a user, a theoretical possibility is the use of GPS data to ensure that wagers are only accepted from users within a permissible proximity of a casino. However, as will be appreciated, the margin-of-error in GPS data renders this method too inexact to solve the problem. A user up to a quarter a mile or more outside the permissible gambling boundary of the casino may still be deemed within the boundary by the imprecision of the GPS data. Likewise, an overly restrictive boundary to account for the margin-of-error would effectively deprive casino patrons within its walls the ability to participate in the wireless gaming activities, thereby frustrating the primary purpose of the wireless gaming services.

Another drawback to Internet-based wireless gaming activities revolves around the security concerns inherent in transferring information in an on-line environment. As will be appreciated, even though a casino patron is on the floor of the casino, with an Internet-based or standard wireless network communication system, any financial information or commands would be routed to a cell tower, then to a satellite, then back down to a cell tower, and then through the casino's Internet service to ultimately reach the gaming server. Then in return, data from the casino server would follow a similar path through the network to communicate gaming information to the casino patron's wireless device. Each step in the communication process is prone to errors, interruptions, and presents opportunities for data to be lost, stolen, or otherwise compromised.

Another drawback of an Internet-based option for mobile gaming within the permissible gambling boundaries of a casino relates back to the current legal and regulatory environment. Today, there exists a body of state and Federal law that regulates or prohibits bank transfers and wagering on sports or games of chance by transmissions in interstate or foreign commerce. Internet and standard wireless network protocols by definition involve interstate transmissions.

Accordingly, gaming enthusiasts are largely left to play casino-type games on mobile devices, such as smartphones, tablets, game players, and the like for fun in a non-wagering environment. The inability to gamble when playing casino games on these devices detracts from their popularity.

The foregoing underscores some of the drawbacks with conventional non-wagering mobile casino games. The foregoing also underscores potential problems with conventional techniques to attempt to limit wireless gaming to users in a limited geographic area. Furthermore, the foregoing highlights the long-felt, yet unresolved need in the art for a mobile and/or wireless gaming device that provide the ability to play for money based on geographic location. In addition, the foregoing highlights the inventor's recognition and need in the art for a mobile gaming device that provides for wage-based gaming in a non-Internet and purely local network environment.

### SUMMARY OF THE INVENTION

The present invention is based, in part, on the inventor's recognition of a need in the art to identify the geographic location of a user before allowing wagering play of casino games on a mobile device. The present invention is also based, in part, on the inventor's recognition that GPS data and Internet-based gaming sessions present problems that compromise or detract from the suitability of today's mobile devices for wagering-based play. The present invention is also based, in part, of the inventor's realization that software available to mobile device users, such as smartphone “apps”, can be used as a vehicle to provide the necessary software to the device to allow non-wagering play when desired and then wagering play only when a user is within a predetermined distance of a proximity node that can communicate locally with the mobile device and provide access to a gaming server.

Furthermore, the present invention is based, in part, on the inventor's realization that the proximity nodes may also serve peripheral purposes in the system such as providing venue information, or any other information, desirous of the gaming server controller to be communicated by sending such information (or responding to requests for information) based on the user's device being detected by a given proximity node in a given venue.

While the present invention will be described in connection with playing casino-type games in a video display format on a mobile device in a casino environment, the present application should be readily understood to include The present specification should be readily understood to include other forms of gambling on other types of devices in other environments. Moreover, one of ordinary skill in the art armed with the present specification will understand and appreciate that the inventions, discoveries, and novel concepts embodied in the teachings of the present application are readily modified and translatable to a variety of fields and uses through routine skill and experimentation.

As will be appreciated by one of ordinary skill in the art, various embodiments of the present invention overcome various of the aforementioned and other disadvantages associated with prior art mobile gaming devices and offers new advantages as well. According to one aspect of various embodiments of the present invention there is provided a casino server in communication with one or more proximity nodes that provide game-playing access to wireless device users within a permissible and acceptable range of the nodes.

In accordance with this aspect of the invention, in certain embodiments the proximity nodes preferably comprise Bluetooth iBeacons, or similar “smart beacon” technology available from Estimote, GeLo, or similar companies. As will be appreciated by one of ordinary skill in the art, any suitable proximity signal technology is deemed within the scope of the invention. Particularly preferred proximity nodes are those configured to receive a signal from a mobile device to indicate the user is within a permissible distance of the node to allow the user access to wager-based gaming programs.

In another presently preferred embodiment, the wireless devices comprise standard smartphone, tablet, or similar portable devices. In accordance with this aspect of the invention, in a preferred embodiment, the wireless devices are provided with software adapted to communicate through the proximity nodes to interact with the casino server. In accordance with this aspect of the invention, the software may comprise an “iPhone App” or similar software application that is downloadable by the wireless device user.

In a related object of the invention, in some preferred embodiments of the invention, the software is configured to have a “wagering” and “non-wagering” application. Preferably, when in communication with a proximity node, a user will have the option of being in a “casino mode” and able to wager on casino games provided by the casino server. When outside the range of any proximity node, the wireless device will default to a “non-wagering” mode, and provide the user with non-wagering play of the casino games.

In certain related embodiments, a user has the option of playing the non-wagering version of the casino games at any time. In certain embodiments, the casino server allows for play of the casino games without wagering. In other embodiments, the software on the device is the source of the non-wagering play.

In accordance with certain objects of the invention, in some embodiments there is provided methods of using the systems of the present invention. According to a presently preferred embodiment, to comport with present legal requirements, the system requires a user to receive authority to access the gaming server with the user's gaming device. In a preferred embodiment, a user registers at the casino in person to receive a “log in” or other access authority parameter. By requiring personal registration, the casino can insure that the person is of an age suitable to engage in gambling activities, and also require the player to pre-fund their wireless gaming session. A local prefunding avoids credit issues or interstate wiring communications that may violate gambling laws.

According to a related aspect of various embodiments of the present invention, a user is also required to check-out in person to cash in any winnings. The desirability of providing an in-person check-out requirement is two-fold. First, it allows the casino to ensure any payout is properly accounted for, reported, and removed from the player's device to avoid double payments or fraud. Secondly, the check-out facilitates a player going to other venues and using the same software to play on other casino gaming servers. By wiping the funds clean at check-out, a second casino cannot be in a position of having to payout funds won at another establishment or otherwise present on the device at check-in at the subsequent casino.

Alternatively, and less preferably because it complicates the system and the local network nature of certain preferred embodiments, the system can be configured to provide remote check-in, check-out and all peripheral functions such as reporting, identification confirmation, etc.

In context of the enabling disclosure, the term “proximity node” should not be construed to limit the scope of the invention to any type, number, or configuration of device capable of detecting a signal from a wireless device, and preferably, providing access to the casino server upon receipt of said signal. Presently preferred technology includes Bluetooth iBeacon, Estimote smart beacons, or GeLo technology.

Likewise, in the context of the enabling disclosure, the term “casino server” should not be construed to limit the scope of the invention to any type, number, or configuration of computer server, network, or system. The term is used generically to refer to any device, database, machine-readable memory, central authority, or system that is capable of providing interactive gaming to a user.

The invention as described and claimed herein should become evident to a person of ordinary skill in the art given the following enabling description and drawings. The aspects and features of the invention believed to be novel and other elements characteristic of the invention are set forth with particularity in the appended claims. The drawings are for illustration purposes only and are not drawn to scale unless otherwise indicated. The drawings are not intended to limit the scope of the invention. The following enabling disclosure is directed to one of ordinary skill in the art and presupposes that those aspects of the invention within the ability of the ordinarily skilled artisan are understood and appreciated.

### BRIEF DESCRIPTION OF THE DRAWINGS

Various aspects and advantageous features of the present invention will become more apparent to those of ordinary skill when described in the detailed description of a preferred embodiment and reference to the accompany drawing wherein:

FIG. 1 depicts a block diagram of an embodiment of a casino incorporating the geographically-based gaming system of the present invention.

FIG. 2 depicts a flow diagram of the steps involved in using an embodiment of the geographically based gaming system of the present invention.

FIG. 3 depicts a flow diagram of the steps involved in playing casino games using an embodiment of the geographically based gaming system of the present invention.

FIG. 4 depicts a flow diagram of the steps involved when a user of a mobile application according to an embodiment of the invention ventures in and out of a casino.

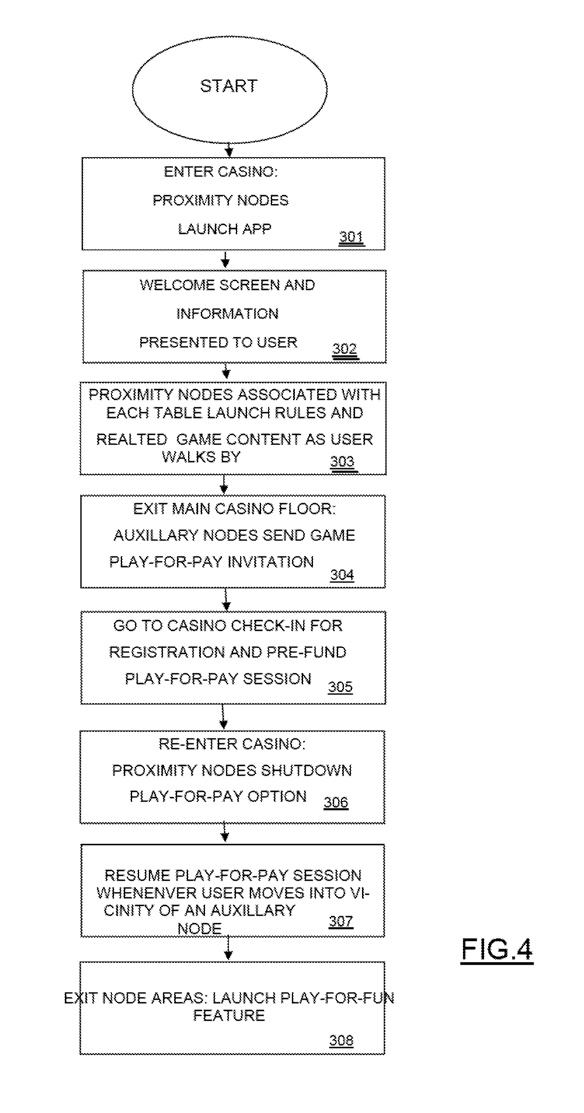

### DETAILED DESCRIPTION OF A PREFERRED EMBODIMENT

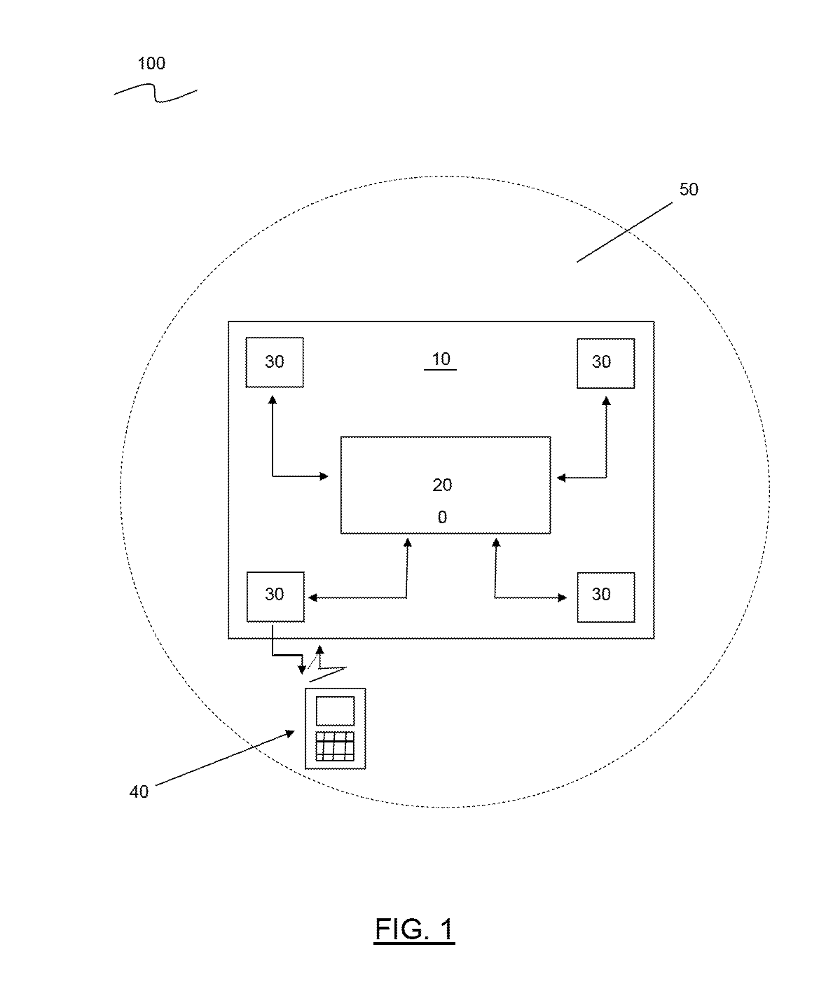

A presently preferred embodiment of a geographically-based, mobile gaming system according to the invention is depicted in FIG. 1. As represented, the system 100 includes a casino 10 having a casino server 20. The casino server 20 is preferably a computer, server, network, or other electronic medium controlled by the casino 10 operator for providing interactive gaming. The casino server 20 functions to provide gaming choices to a user, track the wagers on each play of a game, conduct the games, track the results of the games, report the result, and respond to the user's inputs. As described in more detail below, the casino server 20 may be the vehicle that provides additional information to a user's mobile device during play, such as venue information, casino specials, advertisements from affiliated or sponsored content, third-party paid commercials or advertisements, etc.

The casino server 20 may also be configured to communicate or be accessible by legal or regulatory authorities for audit or compliance inspections/assurances, legal actions, or similar electronic information mining.

Strategically disposed throughout the casino 10 is a plurality of proximity nodes 30. The proximity nodes 30 are configured to detect a mobile device 40 loaded with cooperating software anywhere within a gambling boundary 50 of the casino 10. The proximity nodes 30 are preferably devices that communicate with mobile devices 40 via a direct connection such as infrared, radio, or similar medium that does not require the transmission of information through the Internet or other WAN. The proximity nodes 30 may be based on Bluetooth technology, such as Bluetooth iBeacons, or similar “smart beacon” technology available from Estimote, GeLo, or similar companies.

The proximity nodes 30 serve to confirm that a mobile device 40 is within the legal geographic area of the casino 10 where gambling is permissible. If a user having a mobile device 40 comes within the penumbra 50 of the area of the casino 10 where wagering is legal, one or more proximity nodes 30 detects the signal from the user's device 40 and then provides a pathway for the user's device 40 to communicate with the casino server 20. Once in communication, the user can access the gaming features of the casino server 20 and wager on the server's offerings for so long as the user is within the signal area of one or more proximity nodes 30 associated with the casino server 20. Once too far removed from the proximity of the nodes 30, the communication link is lost, and the user's device can no longer communicate with the server 20.

In a preferred embodiment, the mobile device 40 is loaded with software that automatically switches the user to a “non-wagering” mode when a communication link to the server 20 is lost or unavailable. In the “non-wagering” mode, a user is able to play casino-style video games, such as those offered by the casino server 20, for fun.

The mobile device 40 software for carrying out the methods of preferred embodiments of the invention is preferably loaded onto the device in the form of “app”, such as an iPhone App available from the Apple iStore. The app-format facilitates the ease of configuring a device 40 for mobile play, allows for universality of the communication protocols of the nodes and servers of casinos, and otherwise simplifies all of the desired play, reporting, and peripheral activities of the system when deployed.

As presently preferred, the casino 10 is any building, area, location, or institution allowing waged-based gaming. For illustrative purposes, a traditional brick and mortar hotel and casino, such as those frequented in Las Vegas, Nev., is described. Traditionally, hotels and casinos have a casino floor(s), or dedicated gaming area(s), at the heart of the facility. The casino floor is surrounded by the peripheral offerings of the casino such as shops, hotel guest rooms, spa, pool, restaurants, and banquet and show rooms. Typically, gambling is restricted to the casino floor where patrons remain under the watchful eye of the casino security. In order to gamble, patrons must leave their rooms and be physically present at the tables or games in order to play. A lot of additional revenue may be realized by casinos if they were able to offer gambling opportunities to patrons spread throughout other locations in the establishment, such as guest rooms.

State laws regulate the age and location to participate in legal gambling. A patron's age may be verified when purchasing chips at the casino bank or when otherwise requested by casino security. Being able to monitor those gambling and verifying the age of winners cashing out of the casino is another way that casinos can verify the age of players and otherwise satisfy recording and reporting requirements that are more difficult with remote players. As presently preferred, players are required to register their devices in-person at the casino bank and pre-fund their account for gambling on their wireless devices. Likewise, players are required to check-out of the casino in person, which affords the opportunity to verify the age of the person and clear the device of any credits won at that casino before the player moves on to another venue.

Alternatively, and as will be appreciated, if laws or regulations require more stringent identification requirements, wireless play could be limited to the casino floor to ensure a user's device is not being used by an underage or unauthorized person. However, the present invention contemplates the preferably use of biometrics or other identification technology to be deployed. For example, a user in a guest room could be required to biometrically identify themselves before each play by presenting their fingerprint on the device's screen. All such identification technology should be understood to be compatible with the embodiments of the present invention that lend themselves to such techniques.

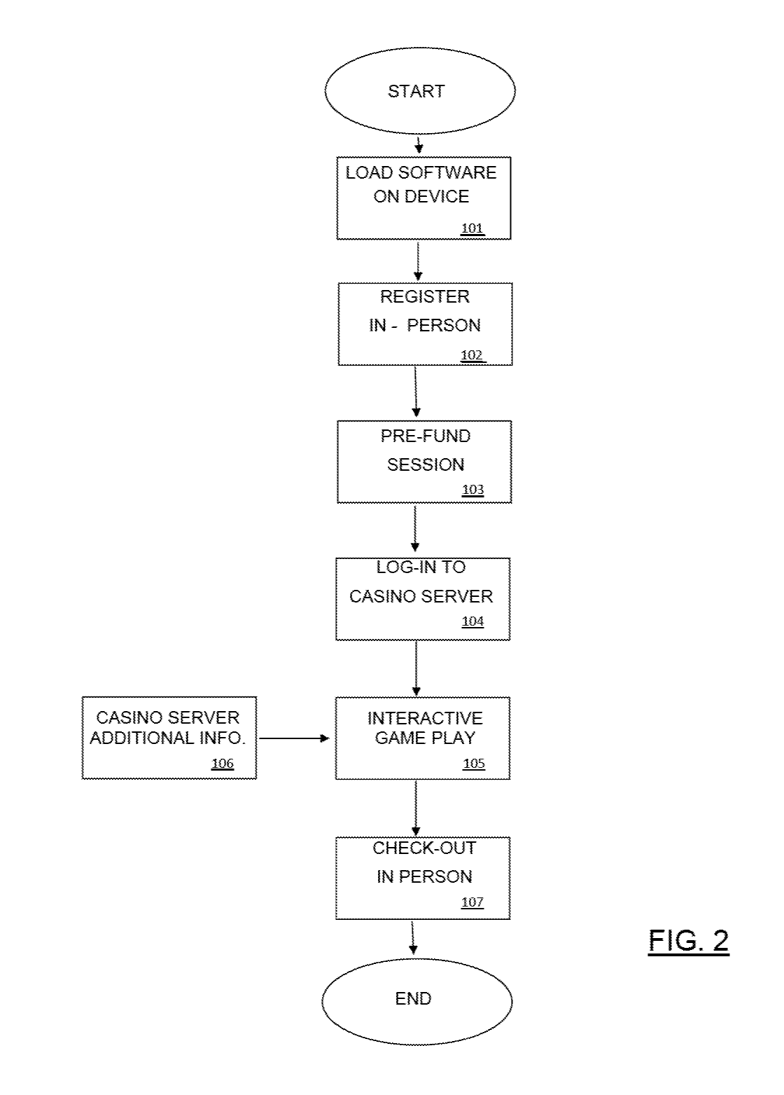

As broadly depicted in the steps of the flow-diagram of FIG. 2, a presently preferred embodiment of the basic system requires in-person check-in and check-out. According to this embodiment, the broad steps in the method of using the system of the present invention starts with the step of loading software onto the gaming device 101. Once armed with the software, a user is preferably provided an icon to click that will display a menu that will allow a user to choose non-wagering play or, when active, wagering play.

A user desiring to use the loaded device in wagering mode must then register in-person with the casino authority 102. The in-person registration process allows for identification and age verification as well as the provision of a log-in or access ID that provides access and tracking of the gaming session for each registered device. While biometric and other identification technologies exist that may be used in connection with various embodiments of the present invention, in-person check in is presently preferred.

As presently preferred, a user must pre-fund their gaming session 103. Preferably, the funding is handled by pre-paying the casino during check-in and having credits stored in a bank feature associated with the gaming software application. While scanning of credit cards and other electronic transfers of money are within the scope of some of the embodiments of the present invention, avoiding any Internet-based communications for use of the system is presently preferred.

Once registered and funded, a user within range of a proximity node 30 is able to login or otherwise access the casino gaming server 104. Upon access, the user interactively chooses a game, places a wager, and plays the game 105. The game can be repeated for additional plays, or the server menu can be navigated for other options. Some or all of the steps of step 105 are repeated throughout the gaming session. During delays, as the user moves and goes from the communication range of different nodes, or otherwise as desired by the casino, information may be displayed or communicated to the user through the device during the gaming session 106. Information about events, specials, options, and advertisements help promote the casino or its affiliates, or otherwise presents a revenue generating vehicle for paid advertisements and the like.

After a user desires to stop playing, add additional funds for additional play, or leave the designated area of the casino for gaming, the user must report to the casino check-out in person 107. The check-out process again allows for the financial issues to be handled, the device's balance to be zeroed out, and the access (if appropriate) of the device to the casino server to be disabled.

Once check out, the user is free to move on to another venue and repeat the process. In various embodiments of the invention presently contemplated, a user can register and prefund a device at check-in or the like and play for money from untraditional gambling areas of the casino, such as guest rooms, pool side, in restaurants, outside the casino, etc.

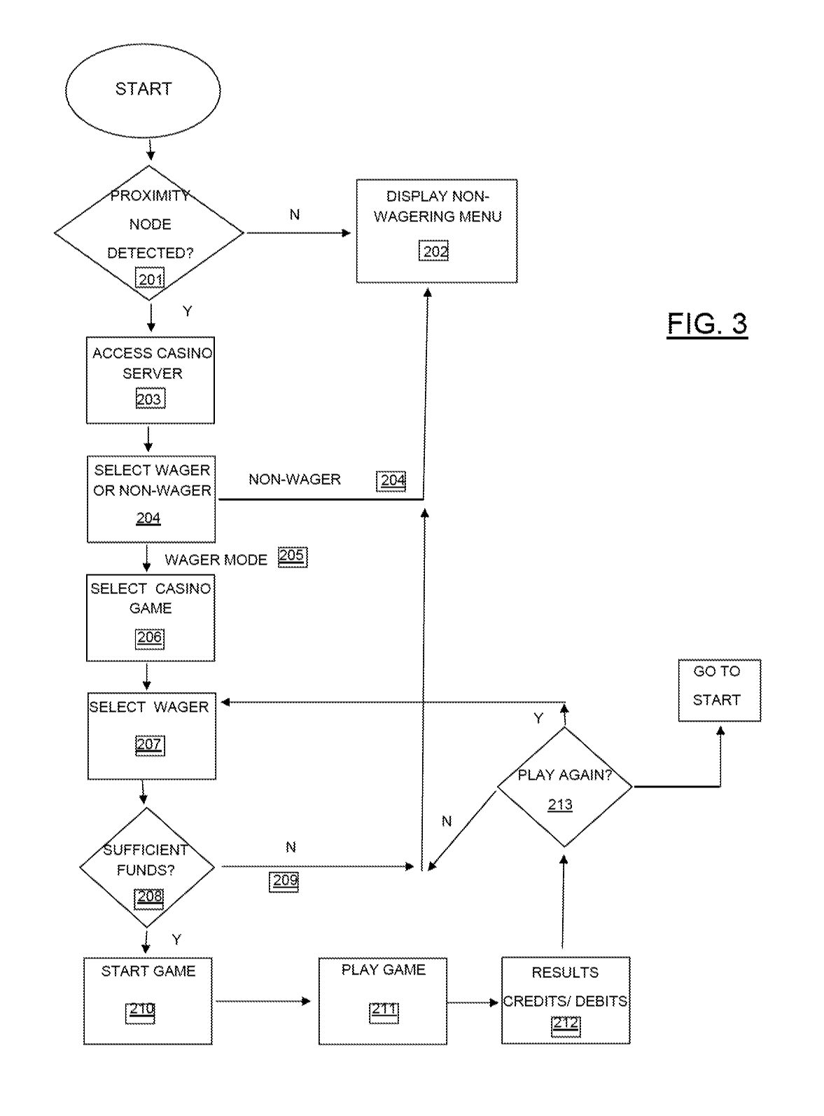

FIG. 3 depicts in greater detail the steps involved in a presently preferred method of using an embodiment of the wagering and non-wagering system of the present invention. As shown in FIG. 3, a device loaded with appropriate software cannot enter a wagering mode until a proximity node is detected and communicated with through traditional computing and communication means 201. If a proximity mode is not detected, the software of the system defaults to a “non-wagering” mode and the user is provided the option of playing casino type games for fun 202.

If a node 30 is detected, the user can access and interact with the casino server 203. Preferably, the user can choose between a wagering and non-wagering mode 204. This ensures that users can play for fun even when within the boundaries of legal gambling. If a user chooses the non-wagering option, the system goes to the “non-wagering” mode 202.

If the user selects the wagering mode 205, the user is provided an interactive menu, or GUI, to select the game the user wishes to play 206. Assuming a signal is still present, the user selects a wager 207 from the available credits, preferably the funds that were paid and loaded at check-in. If there are no funds available 208, the system defaults to the “non-wagering” mode 209. If funds are sufficient, the wager is placed and the casino server starts the game chosen by the user 210.

The game is conducted according to the software 211 using traditional computer techniques to ensure the odds and course of play are equivalent to those of the games as if played in person in a non-video/electronic environment. At the conclusion of the game, the results are presented, recorded, and wager debited or credited 212. The user then has the option of continuing play or going back to the main menu or game choice menu by choosing the desired option presented on the user interface by the casino server 213.

Once the user desires to stop playing, cash out, or leave the casino, the user goes to the casino check-out 214. The user's device is then barred from further access 215.

Preferably, at any time that a user strays from the predetermined geographic proximity to at least one proximity node, the system blocks access to the casino server until the user re-accesses the system from an appropriate geographic proximity.

The above embodiments are for illustrative purposes and are not intended to limit the scope of the invention or the adaptation of the features described herein to particular use, field, or environment. Those skilled in the art will also appreciate that various adaptations and modifications of the above-described preferred embodiments can be configured without departing from the scope and spirit of the invention. Therefore, it is to be understood that, within the scope of the appended claims, the invention may be practiced other than as specifically described.

What is claimed is:

1. A system for wireless gaming with mobile devices having wagering and non-wagering functionality based on geographic location comprising:
a casino server configured to provide interactive video gaming for money to users of the server;
at least one proximity node in communication with said casino server, said proximity node configured to receive a signal from a transmitter within a predetermined proximity of said node;
a mobile computing device comprising a memory including machine-readable software configured to interact with said casino server for placing wagers and playing video versions of casino games when in communication with said casino server for money and further configured to provide a user with a video version of casino games that can be played without wagering; and
a transceiver associated with said mobile computing device for communicating with at least one of said proximity nodes for communicating with said casino when within the predetermined proximity of said node.

2. The system of claim 1 wherein said proximity node communicates through Bluetooth technology.

3. A method of conducting wireless gaming and wagering based on the geographic location comprising the steps of:
providing a proximity node for detecting a signal from a wireless device when within a predetermined distance of said node;
allowing said wireless device to access a casino server when said device is detected by said proximity node;
receiving wagering and player input through said wireless device for communicating to said casino server to conduct the wireless gaming and wagering for so long as said proximity node detects said wireless device.

4. The method of claim 3 wherein said wireless device and casino server communicate through local communications protocols.

5. A method of conducting wireless gambling on a mobile device within a predetermined geographic area comprising the steps of:
loading software on a mobile device configured to interact with a casino server providing games of chance;
registering the device with a casino authority and pre-funding an allotment of wagers;
accessing said casino server through a proximity node that requires a user to be within a signal-detectable distance to said node to ensure said user is within a prescribed geographically permissible area to participate in legal gambling;
conducting wagering based computer play between said wireless device and said casino server for so long as the wireless device is within said signal detectable-distance of said node;
tracking said course of play and reporting results and tabulating a running total of wagers; and
checking out said device by wiping the wager volume and paying out any wager volume that was above zero.
